(19) United States
(12) Patent Application Publication
(10) Pub. No.: US 2018/0120078 A1
(43) Pub. Date: May 3, 2018

(54) FLATNESS MEASURING DEVICE

(71) Applicant: INDUSTRIAL TECHNOLOGY RESEARCH INSTITUTE, Hsinchu (TW)

(72) Inventors: Chun-Hsien Chen, Jhubei City (TW); Shu-Ping Dong, Taichung City (TW); Tapilouw Abraham MARIO, Hsinchu County (TW)

(21) Appl. No.: 15/404,776

(22) Filed: Jan. 12, 2017

(30) Foreign Application Priority Data
Oct. 27, 2016 (TW) 105134752

(51) Int. Cl. G01B 5/20; G01B 3/18

(52) U.S. Cl. CPC G01B 5/20; G01B 3/18

(57) ABSTRACT

A flatness measurement device includes a movement platform, a standard component, a first flatness measuring device, a second flatness measuring device and a processor. The movement platform is used for driving a to-be-measured object to move. The standard component and the movement platform move together. The first flatness measuring device is used for measuring a first flatness information of the to-be-measured object when the to-be-measured object moves. The second flatness measuring device is used for measuring a second flatness information of the standard component when the standard component moves. A flatness information of the to-be-measured object is obtained by deducting the second flatness information from the first flatness information by the processor.

This application claims the benefit of Taiwan application Serial No. 105134752, filed Oct. 27, 2016, the subject matter of which is incorporated herein by reference.

### TECHNICAL FIELD

The disclosure relates in general to a flatness measuring device, and more particularly to a flatness measuring device having a flatness measurer.

### BACKGROUND

Due the mechanic design error and manufacturing error, conventional flatness measuring device will inevitably generate X-axial movement error when measuring surface flatness of a to-be-measured object. The X-axial movement error affects the measured value of the flatness of the to-be-measured object. Therefore, it has become a prominent task for the industries to provide a new technique to resolve the above problems.

### SUMMARY

According to one embodiment of the present disclosure, a flatness measuring device is provided. The flatness measuring device includes a movement platform, a standard component, a first flatness measurer, a second flatness measurer and a processor. The movement platform is for driving a to-be-measured object to move. The standard component and the movement platform move collaboratively. The first flatness measurer is for measuring a first flatness information when the to-be-measured object moves. The second flatness measurer is for measuring a second flatness information when the standard component moves. The processor is for deducting the second flatness information from the first flatness information to obtain the flatness information of the to-be-measured object.

According to another embodiment of the present disclosure, a flatness measuring device is provided. The flatness measuring device includes a movement platform, a standard component, a chromatic confocal measurer and a processor. The movement platform is for driving a to-be-measured object to moves. The standard component and the movement platform move collaboratively. The chromatic confocal measurer is for measuring a first flatness information when the to-be-measured object moves and measuring a second flatness information when the standard component moves. The processor is for deducting the second flatness information from the first flatness information to obtain the flatness information of the to-be-measured object.

The above and other aspects of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of a flatness measuring device according to an embodiment of the disclosure.

FIG. 2 is a measurement result of the flatness measuring device of FIG. 1.

FIG. 3 is a schematic diagram of a flatness measuring device according to another embodiment of the disclosure.

FIG. 4 is a schematic diagram of a flatness measuring device according to another embodiment of the disclosure.

FIG. 5 is a relationship diagram of wavelength vs intensity of the measuring light of FIG. 4.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF THE DISCLOSURE

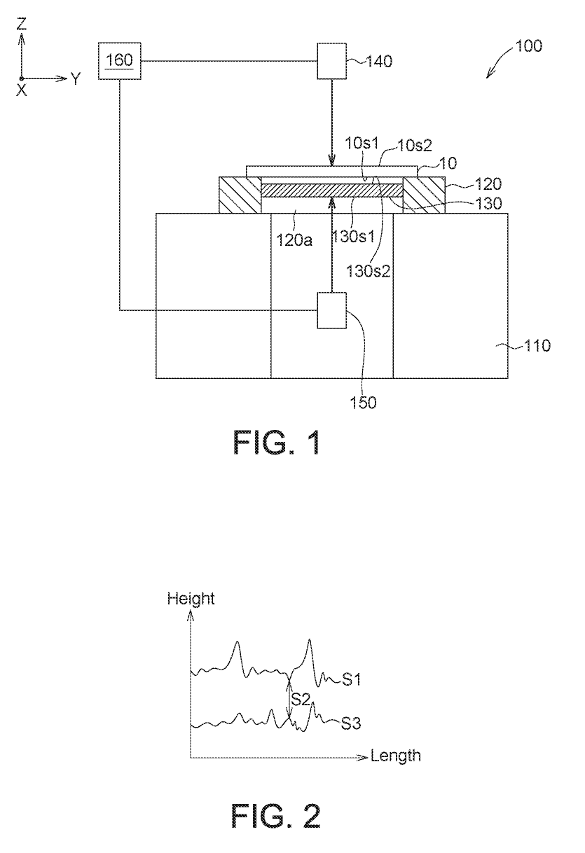

Refer to FIG. 1 and FIG. 2. FIG. 1 is a schematic diagram of a flatness measuring device 100 according to an embodiment of the disclosure. FIG. 2 is a measurement result of the flatness measuring device 100 of FIG. 1.

The flatness measuring device 100 includes a base 110, a movement platform 120, a standard component 130, a first flatness measurer 140, a second flatness measurer 150 and a processor 160.

The first flatness measurer 140 and the second flatness measurer 150 are fixed with respect to the base 110, that is, the first flatness measurer 140 and the second flatness measurer 150 do not move. In an embodiment, the first flatness measurer 140 is a micrometer gauge, a linear variable differential transformer (LVDT) displacement sensor or other mechanic or electronic measuring device capable of measuring flatness information.

The movement platform 120 can be movably disposed on the base 110. The to-be-measured object 10 and the standard component 130 are disposed on the movement platform 120, wherein the movement platform 120 can drive the to-be-measured object 10 and the standard component 130 to move collaboratively. That is, there is no relative movement between the to-be-measured object 10 and the standard component 130.

The to-be-measured object 10 and the standard component 130 are interposed between the first flatness measurer 140 and the second flatness measurer 150. In the present embodiment, the to-be-measured object 10 and the standard component 130 are separated from each other or have mutual contact.

The to-be-measured object 10 has a first surface 10s1 and a to-be-measured surface 10s2 disposed oppositely. The standard component 130 has a standard surface 130s1 and a second surface 130s2 disposed oppositely. The first surface 10s1 of the to-be-measured object 10 and the second surface 130s2 of the standard component 130 face each other, the to-be-measured surface 10s2 of the to-be-measured object 10 faces the first flatness measurer 140, and the standard surface 130s1 of the standard component 130 faces the second flatness measurer 150.

As indicated in FIG. 2, the first flatness measurer 140 is for measuring the first flatness information S1 of the to-be-measured surface 10s2 when the to-be-measured object 10 moves; the second flatness measurer 150 is for measuring the second flatness information S2 of the standard surface 130s1 when the standard component 130 moves. The processor 160 can deduct the second flatness information S2 from the first flatness information S1 to obtain the flatness information S3 of the to-be-measured surface 10s2 of the to-be-measured object 10. In comparison to the generally known measuring method, the error occurring when the movement platform 120 moves has been deducted from the flatness information S3 in the present embodiment, therefore the flatness information S3 is closer to the real or actual flatness information, such as flatness, of the to-be-measured surface 10s2.

As indicated in FIG. 2, due to the mechanic design error and manufacturing error, a large error, such as Z-axial error, will generate when the movement platform 120 moves. Since the movement platform 120 and the to-be-measured object 10 move collaboratively, the measured first flatness information S1 contains the large error generated when the movement platform 120 moves and the flatness information of the to-be-measured surface 10s2 of the to-be-measured object 10. However, since the standard surface 130s1 of the standard component 130 has an ideal or a tiny flatness, the second flatness information S2 merely contains the large error generated when the movement platform moves. Thus, the information obtained by deducting the second flatness information S2 from the first flatness information S1 is the actual flatness information S3 of the to-be-measured surface 10s1 of the to-be-measured object 10. Regardless of the large error generated when the movement platform 120 moves, the flatness measuring device 100 of the embodiments of the disclosure all can measure actual flatness information S3 of the to-be-measured object 10. In an embodiment, the flatness of the standard surface 130s1 ranges between 1 micrometer (μm) and 1 millimeter (mm).

As indicated in FIG. 1, the movement platform 120 has a penetration portion 120a. In the present embodiment, the standard component 130 is disposed inside the penetration portion 120a, for example, on the sidewall of the penetration portion 120a, such that the second flatness measurer 150 can measure the second flatness information S2 of the standard surface 130s1 through the penetration portion 120a. In the present embodiment, the standard component 130 can be a transparent standard component or a translucent or an opaque standard component.

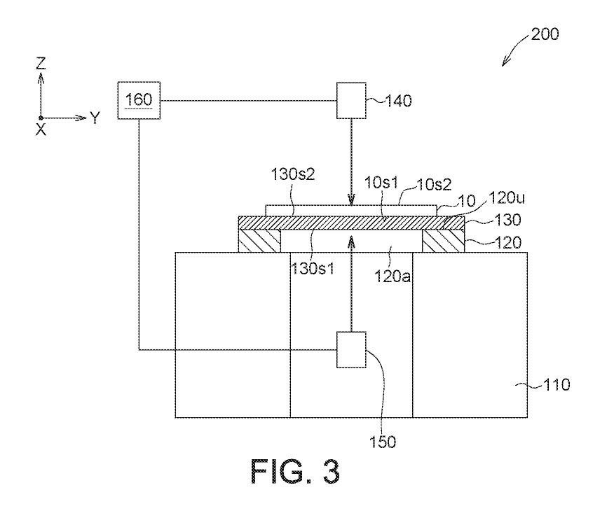

Referring to FIG. 3, a schematic diagram of a flatness measuring device 200 according to another embodiment of the disclosure is shown. The flatness measuring device 200 includes a base 110, a movement platform 120, a standard component 130, a first flatness measurer 140, a second flatness measurer 150 and a processor 160.

The features of the flatness measuring device 200 of the present embodiment are similar to that of the flatness measuring device 100 of the above embodiments except that the standard component 130 of the flatness measuring device 200 can be disposed on the upper surface 120u of the movement platform 120, and the to-be-measured object 10 and the standard component 130 have mutual contact. Although it is not illustrated in the diagram, the to-be-measured object 10 can be fixed on the upper surface 120u of the movement platform 120 by way of temporary connection such as engaging or locking.

Referring to FIG. 4, a schematic diagram of a flatness measuring device 300 according to another embodiment of the disclosure is shown. The flatness measuring device 300 includes a base 110, a movement platform 120, a standard component 130, a chromatic confocal measurer 340 and a processor 160. In comparison to the flatness measuring device 100 of above embodiments, the flatness measurer of the flatness measuring device 300 of the present embodiment is a chromatic confocal measurer, and the quantity of the chromatic confocal measurer can be one.

The movement platform 120 can be movably disposed on the base 110. The to-be-measured object 10 and the standard component 130 are disposed on the movement platform 120, and the movement platform 120 can drive the to-be-measured object 10 and the standard component 130 to move collaboratively. That is, there is no relative movement between the to-be-measured object 10 and the standard component 130.

The standard component 130 is interposed between the to-be-measured object 10 and the chromatic confocal measurer 340. The to-be-measured object 10 has a first surface 10s1 and a to-be-measured surface 10s2 disposed oppositely. The standard component 130 has a standard surface 130s1 and a second surface 130s2 disposed oppositely. The to-be-measured surface 10s2 of the to-be-measured object 10 and the standard surface 130s1 of the standard component 130 face each other, and the second surface 130s2 of the standard component 130 faces the chromatic confocal measurer 340, such that the measuring light of the chromatic confocal measurer 340 penetrates the second surface 130s2 and then reaches the to-be-measured surface 10s2 of the to-be-measured object 10 and the standard surface 130s1 of the standard component 130 to measure the first flatness information S1 of the to-be-measured surface 10s2 and the second flatness information S2 of the standard surface 130s1.

The chromatic confocal measurer 340 can emit a measuring light with several wavelengths. The depth of the focal point of each wavelength of the measuring light varies with the wavelengths of the measuring light. When the focal point of the measuring light falls on the to-be-measured surface 10s2 or the standard surface 130s1, the measuring light will be reflected to the chromatic confocal measurer 340. Based on the reflected lights, the processor 160 calculates the first flatness information S1 of the to-be-measured surface 10s2 of the to-be-measured object 10 and the second flatness information S2 of the standard surface 130s1 of the standard component 130, and then deducts the second flatness information S2 from the first flatness information S1 to obtain the flatness information S3 of the to-be-measured object 10.

For example, the focal point F1 of the first wavelength light L1 with the first wavelength falls on the to-be-measured surface 10s2 and is then reflected to the chromatic confocal measurer 340 from the to-be-measured surface 10s2. The focal point F2 of the second wavelength light L2 with the second wavelength falls on the standard surface 130s1 and is then reflected to the chromatic confocal measurer 340 from the standard surface 130s1. The first wavelength light L1 and the second wavelength light L2 are split lights of the measuring light, and the first wavelength and the second wavelength are different from each other. In the embodiments of the disclosure, the quantity of wavelength lights with different wavelengths is not subject to particular restrictions.

The chromatic confocal measurer 340 or the processor 160 calculates the first flatness information S1 and the second flatness information S2 according to the reflected first wavelength light L1 and the reflected second wavelength light L2 respectively. Then, the processor 160 deducts the second flatness information S2 from the first flatness information S1 to obtain the flatness information S3 of the to-be-measured surface 10s2 of the to-be-measured object 10. In an embodiment, the processor 160 can be integrated with the chromatic confocal measurer 340 or disposed independently of the chromatic confocal measurer 340.

As indicated in FIG. 4, in the present embodiment, the to-be-measured object 10 and the standard component 130 are separated from each other by a distance d1. The depth of the focal point of each wavelength of the measuring light emitted by the chromatic confocal measurer 340 is distributed within a focusing range R1. The to-be-measured surface 10s2 of the to-be-measured object 10 and the standard surface 130s1 of the standard component 130 are located within the focusing range R1. That is, the distance d1 between the to-be-measured surface 10s2 and the standard surface 130s1 is smaller than the focusing range R1 and is within the focusing range R1. Thus, the measuring light can measure the flatness information of the to-be-measured surface 10s2 and the standard surface 130s1.

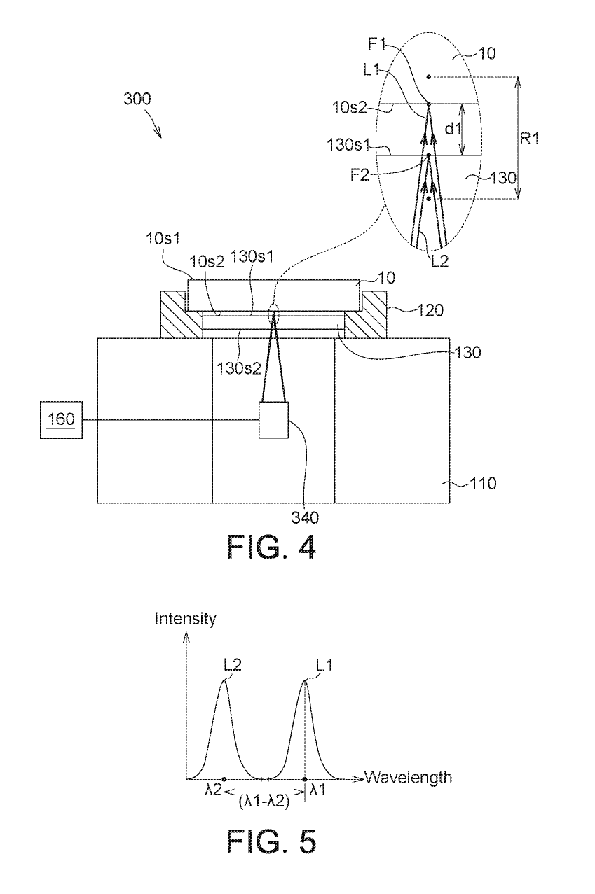

Referring to FIG. 5, a relationship diagram of wavelength vs intensity of the measuring light of FIG. 4 is shown. Let the first wavelength light L1 with the first wavelength and the second wavelength light L2 with the second wavelength of the measuring lights be taken for example. The distance d1 is larger or substantially equivalent to the difference between the first wavelength light L1 with the first wavelength light L1 and the second wavelength light L2 with the second wavelength light L2, such that the signal of the reflected first wavelength light L1 and the signal of the reflected second wavelength light L2 will not over-interfere with each other and affect the accuracy of flatness.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A flatness measuring device, comprising:
a movement platform for driving an to-be-measured object to move;
a standard component moving collaboratively with the movement platform;
a first flatness measurer for measuring a first flatness information when the to-be-measured object moves;
a second flatness measurer for measuring a second flatness information when the standard component moves; and
a processor for deducting the second flatness information from the first flatness information to obtain flatness information of the to-be-measured object.

2. The flatness measuring device according to claim 1, wherein the first flatness measurer is a micrometer gauge or a linear variable differential transformer displacement sensor.

3. The flatness measuring device according to claim 1, wherein the to-be-measured object and the standard component are interposed between the first flatness measurer and the second flatness measurer.

4. The flatness measuring device according to claim 1, wherein the to-be-measured object and the standard component are separated from each other.

5. The flatness measuring device according to claim 1, wherein the to-be-measured object has a to-be-measured surface and a first surface opposite to the to-be-measured surface, the standard component has a standard surface and a second surface opposite to the standard surface, the first surface and the second surface face each other, the first flatness measurer is for measuring the first flatness information of the to-be-measured surface, and the second flatness measurer is for measuring the second flatness information of the standard surface.

6. The flatness measuring device according to claim 1, wherein the movement platform has a penetration portion through which the second flatness measurer measures the second flatness information of the standard surface.

7. The flatness measuring device according to claim 1, wherein the standard component is a transparent standard component.

8. The flatness measuring device according to claim 1, wherein the standard component is an opaque standard component.

9. A flatness measuring device, comprising:
a movement platform for driving an to-be-measured object to move;
a standard component moving collaboratively with the movement platform;
a chromatic confocal measurer for measuring a first flatness information when the to-be-measured object moves and measuring a second flatness information when the standard component moves; and
a processor for deducting the second flatness information from the first flatness information to obtain flatness information of the to-be-measured object.

10. The flatness measuring device according to claim 9, wherein the standard component is interposed between the chromatic confocal measurer and the to-be-measured object.

11. The flatness measuring device according to claim 9, wherein the to-be-measured object and the standard component are separated from each other.

12. The flatness measuring device according to claim 9, wherein the to-be-measured object has a to-be-measured surface, the standard component has a standard surface and a second surface disposed oppositely, the to-be-measured surface and the standard surface face each other, the second surface faces the chromatic confocal measurer, and the measuring light of the chromatic confocal measurer measures the first flatness information of the to-be-measured surface and the second flatness information of the standard surface through the second surface.

13. The flatness measuring device according to claim 12, wherein the chromatic confocal measurer has a focusing range within which the to-be-measured surface and the standard surface are located.

14. The flatness measuring device according to claim 9, wherein the standard component is a transparent standard component.
